(19) United States
(12) Patent Application Publication
(10) Pub. No.: US 2013/0037557 A1
(43) Pub. Date: Feb. 14, 2013

(54) Container with removable bottom

(71) Applicant: Nicholas Sie Yong Ting, Calgary (CA)

(72) Inventor: Nicholas Sie Yong Ting, Calgary (CA)

(21) Appl. No.: 13/137,378

(22) Filed: Aug. 10, 2011

(51) Int. Cl. B65D 8/04; B67D 7/06; B05C 17/00

(52) U.S. Cl. 220/693; 222/278; 220/4.01

(57) ABSTRACT

A container having a container body extending between first and second opposed ends. The first end includes a dispensing means, the second end has a removable cap having a second end surface of the container and being connectable to the container by a connector spaced apart from a bottom of the second end surface. A method for opening the container comprising removing an annular frangible portion around a radius of a container body of the container, and removable separating end cap opposite a dispensing portion from the container such that the end cap forms a cup shape having an upright wall separating a bottom wall of the container and a connector for connecting to the container body for holding a portion of the contents of the container.

### BACKGROUND OF THE INVENTION

1. Field of Invention

The present invention relates to containers in general and in particular to containers with removable bottoms.

2. Description of Related Art

Dispensing containers are commonly used for dispensing creams liquids and gels, such as by way of non-limiting example, skin creams, lotions or liquid soap. Such containers typically comprise an upright container body having a base or bottom end and a dispenser, such as a pump dispenser on an opposed top end thereof.

Commonly, such dispensers may include a pump dispenser having a pick-up tube extending from the top end of the container to a bottom end. The pick-up tube draws in the contents of the container for dispensing through the pump. One common difficulty with such containers is that a portion of the contents of the container are difficult to remove from the container resulting in wasted material that is often thrown out or otherwise disposed of. It will be appreciated that this additional material remaining within the container may adversely affect recycling of the container.

One reason for this difficulty is that although the pick-up tube is located proximate to the bottom of the container, it will only be proximate to the center of the bottom and be slightly spaced apart therefrom so as to prevent the pick-up tube from being blocked by the bottom surface and therefore some of the contents of the container will not be reachable by the pick-up tube. Where the contents of the container are thicker, such as for lotions, creams or gels, the contents of the container located in the corners of the container will not be able to be picked up by the pick-up tube and will therefore be left behind.

Previous attempts to remove the remaining contents from the bottom of such containers has been unsatisfactory. Although many people dispose of such containers with the remaining contents therein, some people have attempted to either continuously dip the pick-up tube into the corners of the container to reach the contents thereof. Other attempts have been to cut open the container to reach the remainder of the contents. Disadvantageously, such attempts require the container to be damaged or destroyed in such a process. Additionally, thereafter, the container is incapable of being re-sealed such that the contents may be spoiled or dried by contact with the air.

### SUMMARY OF THE INVENTION

According to a first embodiment of the present invention there is disclosed a container having a container body extending between first and second opposed ends. The first end including a dispensing means, the second end has a removable cap having a second end surface of the container and being connectable to the container by a connector spaced apart from a bottom of the second end surface.

The removable cap may include a bottom wall and an upright wall extending around a periphery thereof. The connector may be located proximate to distal edge of the upright wall. The connector may comprise threading on an interior of surface of the upright wall. The interior threading may be engageable with corresponding exterior threading on the container body.

The connector may comprise an annular ridge extending around an interior surface of the upright wall proximate to the distal edge thereof. The annular ridge may be engagable upon a corresponding raised portion on an exterior surface of the container body.

The apparatus may further comprise a removable portion extending around the container between a junction formed between the connector and the container body so as to cover the junction. The removable portion may be frangibly connected to the container body and the removable cap. The removable portion has an exposed pull tab.

The container may have a substantially circular cross section. The container may have a substantially rectangular cross section

According to a further embodiment of the present invention there is disclosed a method for opening a container. The method comprises removing an annular frangible portion around a radius of a container body of the container, and removable separating end cap opposite a dispensing portion from the container such that the end cap forms a cup shape having an upright wall separating a bottom wall of the container and a connector for connecting to the container body for holding a portion of the contents of the container.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a container according to a first embodiment of the present invention.

FIG. 2 is a perspective view of the container of FIG. 1 with a removable strip partially removed.

FIG. 3 is a perspective view of the container of FIG. 1 with a bottom cap removed.

FIG. 4 is a cross sectional view of the container of FIG. 1 as taken along the line 4-4 of FIG. 1.

FIG. 5 is a perspective view of a container according to a further embodiment of the present invention with a bottom cap removed.

### DETAILED DESCRIPTION

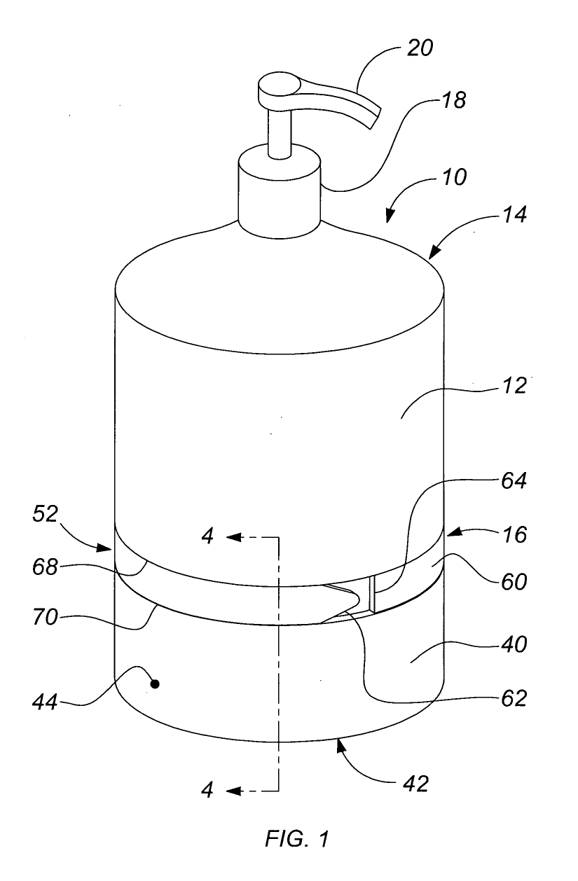

Referring to FIGS. 1 through 3, a container according to a first embodiment of the invention is shown generally at 10. The container 10 is formed by a container body 12 extending between first or top and second or bottom ends, 14 and 16, respectively. The top end 14 narrows to a cap portion 18 having a hand pump 20 or other suitable dispenser as are known in the art. The bottom end 16 is connectable to a bottom cap 40 as will be more fully described below.

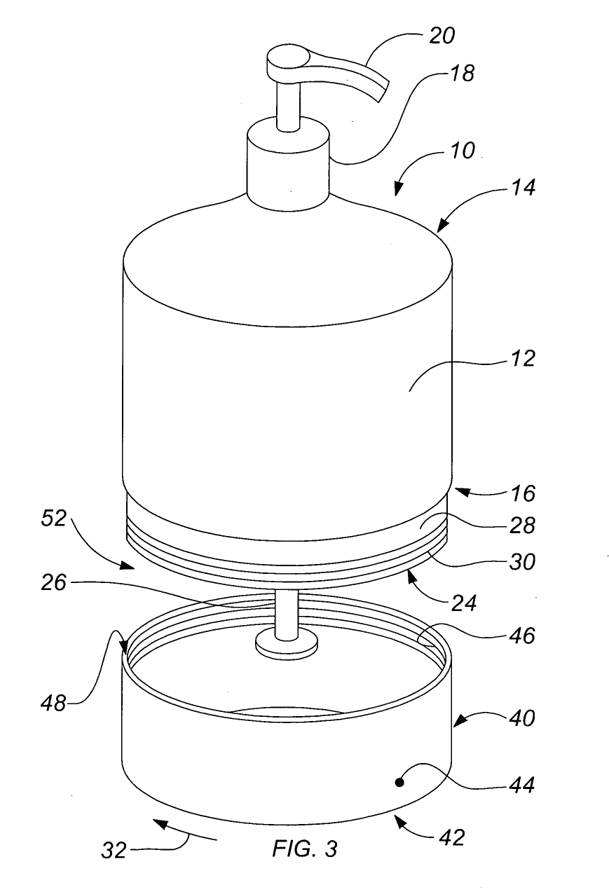

The container body 12 is formed by a container wall 22 having a central cavity 24 (not shown in FIG. 1) therein. The central cavity 24 is operable to contain a container content, which may comprise, by way of non-limiting example any known fluid, cream, gel or lotion. As illustrated in FIG. 3, the hand pump 20 may have a pick-up tube 26 extending into the central cavity 24 as are known in the art to draw the contents thereinto for dispensing through the hand pump. It will be appreciated that other dispenser types may be utilized as well, such as, by way of non-limiting example, orifices for use in a flexible or squeeze bottle, a spout, or an electric pump.

At the bottom end 16 of the container body 12, the upright wall may include a narrowed portion 28 having exterior threading 30 or another suitable connection means. The exterior threading is sized and selected to have a corresponding threading or connection on the bottom cap as will be described below.

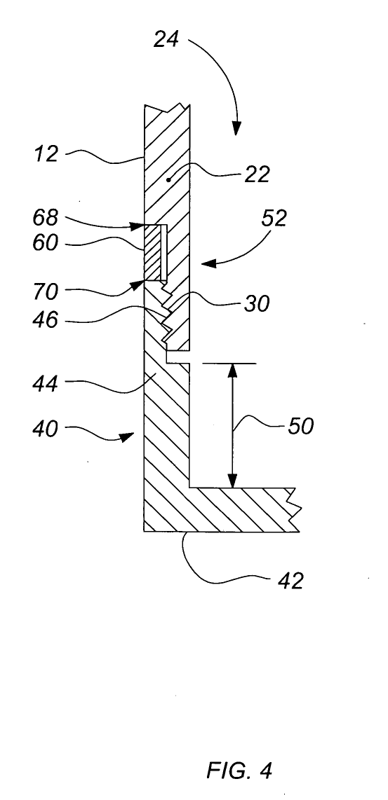

The bottom cap 40 comprises a cup shaped body having a bottom panel 42 and an upright wall 44 extending therefrom. The upright wall 44 includes internal threading 46 proximate to a distal edge 48 of the upright wall 44. The external threading 30 of the container body 12 and the internal threading 46 of the bottom cup 40 form a connector, generally indicated at 52 therebetween for connecting the container body 12 and bottom cap 40 together to form a common container 10. The internal threading 46 is spaced apart from the bottom panel 42 by a distance or spacing generally indicated at 50 in FIG. 4. The spacing 50 may be selected to provide separation of the connector 52 and the bottom panel 42 of the bottom cap. In this way, material contained within the container will not come into contact with the connector 52 when the bottom cap 40 is removed from the container body 12 as described below. The spacing distance may be selected to ensure that the contents of the container do not come into contact with the connector 52 based upon the material properties of the contents, such as the viscosity of the contents. By way of non-limiting example, the spacing distance may be selected to be between 5 and 25% of the total height of the container or between 1/32 and 1½ inches (1 and 38 mm) with a distance of between 1/32 and ¼ inches (1 and 6 mm) being found to be particularly useful although it will be appreciated that other distances may be useful as well. For wider containers or contents having a greater viscosity, larger spacing distances 50 may be necessary. It will be appreciated that the pick-up tube 26 will extend below the connection to assist in preventing the contents from coming into contact with the connector 52.

The container 10 may optionally include a removable strip 60 extending around and covering the connector 52. The strip extends between first and second ends, 62 and 64, respectively. The first end 62 has a free portion which may be grasped by a user for ease of removal. The removable strip 60 has to and bottom edges, 68 and 70, respectively and may be connected to the container body and bottom cap by a frangible connection.

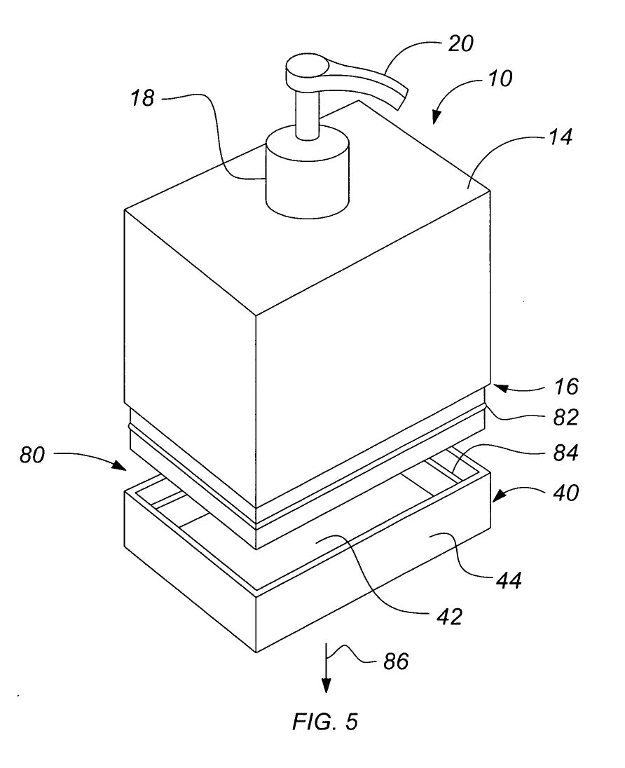

Turning now to FIG. 5, an optional embodiment of the present invention is illustrated. As illustrated in FIG. 5, the container may have a substantially rectangular cross-section. It will be appreciated, however, that any other cross-sectional shape may be utilized, such as circular, as illustrated in FIGS. 1 through 3, octagonal, triangular, or irregular. The connector 80 as illustrated in FIG. 5 may be formed by a ridge 82 extending from the exterior surface of the container body 12 and a corresponding groove 84 extending around the interior of the bottom cap 40. The ridge is received within the groove so as to frictionally retain the bottom cap on the container body.

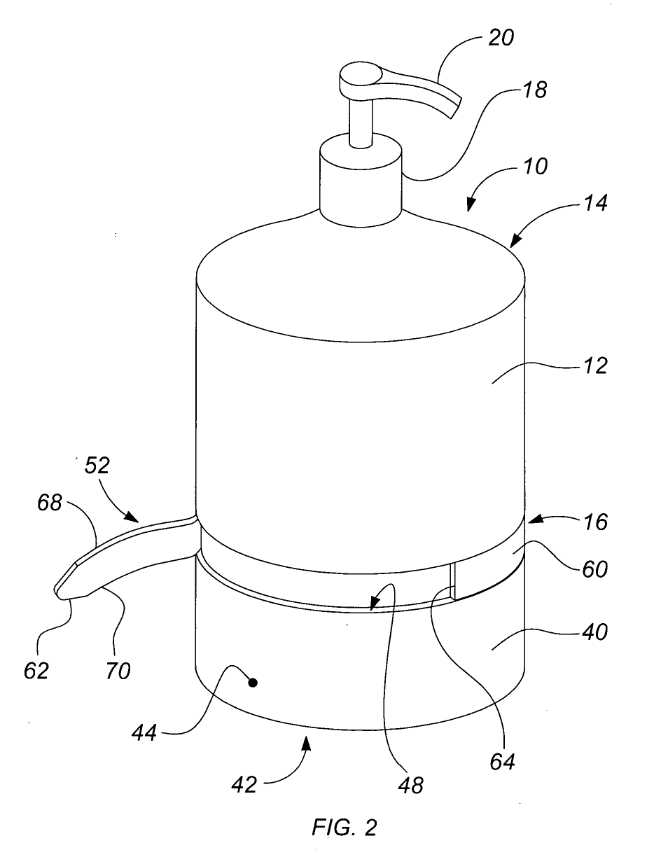

In operation, the container 10 be sold or otherwise provided to a user with the removable strip 60 covering or otherwise containing the connection and assisting in maintaining continuity of the container body 12 with the bottom cap 40. It will be appreciated that the container 10 may either be provided to the user filled with a desired content or be filled by the user. When the pick-up tube 26 is no longer able to draw contents out of the container, the user may grasp the first free end 62 of the removable strip and tear it away along the frangible connections at the top and bottom edges 68 and 70 as illustrated in FIG. 2. Thereafter the bottom cap 40 may be either threadably removed from the container body 12 by rotating it in a direction generally indicated at 32 as illustrated in FIG. 3. Optionally, the bottom cap 40 may be pulled off of the container body 12 by pulling it in a direction generally indicated at 86 in FIG. 5. Once removed, the bottom cap 40 will contain the remainder of the container contents for access by the user. After use, the user may then optionally replace the bottom cap 40 upon the container body for future access by reversing the above operation.

While specific embodiments of the invention have been described and illustrated, such embodiments should be considered illustrative of the invention only and not as limiting the invention as construed in accordance with the accompanying claims.

What is claimed is:

1. A container having a container body extending between first and second opposed ends, said first end including a dispensing means, said second end having a removable cap, said removable cap having a second end surface of said container and being connectable to said container by a connector spaced apart from a bottom of said second end surface.

2. The apparatus of claim 1 wherein said removable cap includes a bottom wall and an upright wall extending around a periphery thereof.

3. The apparatus of claim 2 wherein said connector is located proximate to distal edge of said upright wall.

4. The apparatus of claim 3 wherein said connector comprises threading on an interior of surface of said upright wall.

5. The apparatus of claim 4 wherein said interior threading is engagable with corresponding exterior threading on said container body.

6. The apparatus of claim 3 wherein said connector comprises an annular ridge extending around an interior surface of said upright wall proximate to said distal edge thereof.

7. The apparatus of claim 6 wherein said annular ridge is engagable upon a corresponding raised portion on an exterior surface of said container body.

8. The apparatus of claim 1 wherein further comprising a removable portion extending around said container between a junction formed between said connector and said container body so as to cover said junction.

9. The apparatus of claim 8 wherein said removable portion is frangibly connected to said container body and said removable cap.

10. The apparatus of claim 9 wherein said removable portion has an exposed pull tab.

11. The apparatus of claim 1 wherein said container has a substantially circular cross section.

12. The apparatus of claim 1 wherein said container has a substantially rectangular cross section

13. A method for opening a container, the method comprising removing an annular frangible portion around a radius of a container body of said container, and removable separating end cap opposite a dispensing portion from said container such that said end cap forms a cup shape having an upright wall separating a bottom wall of said container and a connector for connecting to said container body for holding a portion of the contents of said container.
